(19) United States
(12) Patent Application Publication
(10) Pub. No.: US 2022/0143889 A1
(43) Pub. Date: May 12, 2022

(54) ANNULAR NOZZLE

(71) Applicant: Promix Solutions AG, Winterthur (CH)

(72) Inventor: Rolf Heusser, Winterthur (CH)

(73) Assignee: Promix Solutions AG, Winterthur (CH)

(21) Appl. No.: 17/520,088

(22) Filed: Nov. 5, 2021

(30) Foreign Application Priority Data
Nov. 12, 2020 (EP) 20207332.6

(51) Int. Cl. B29C 48/325; B29C 48/30; B29C 48/10

(52) U.S. Cl. CPC B29C 48/325; B29L 2023/001; B29C 48/10; B29C 48/302

(57) ABSTRACT

An annular nozzle contains a nozzle body, the nozzle body comprising at least one annular gap for the discharge of a film. The annular gap is laterally bounded by a stationary wall and a flexible lip. A plurality of threaded pins and a corresponding number of bolts are arranged in the nozzle body. Each of the threaded pins is rotatably mounted in a first bore in the nozzle body. Each of the bolts is slidably mounted in the nozzle body in a second bore in the nozzle body. The bolt is in contact with the flexible lip and the corresponding threaded pin so that a compressive force can be transferred from the threaded pin to the bolt and via the bolt to the flexible lip.

### CROSS-REFERENCE TO RELATED APPLICATION

This application claims priority to European patent application no. EP 20207332.6, filed Nov. 12, 2020, the content of which is hereby incorporated by reference in its entirety.

### BACKGROUND

The present invention relates to an annular nozzle which is used for producing a film. In particular, the thickness of the film can be adjusted by means of the annular nozzle, for example a plastic film, in particular a foamed plastic film. Such annular nozzles are used in the production of foamed plastic films from a plastic melt, for example PE, PP or PS. The plastic melt loaded with blowing agent emerges as a hose from the annular nozzle and foams up in the process. During the foaming, the film thickness increases considerably. It is therefore difficult to keep the thickness of the foamed film exactly the same at every point of the cross section forming the circumference, in other words to produce a film cross section with a constant thickness.

### DESCRIPTION OF RELATED ART

The thickness of the film of a foamed film that emerges from an annular nozzle can be adjusted by means of a flexible lip. The flexible lip comprises a wall that delimits an annular gap that forms the annular nozzle. The foamable film emerges through the annular gap to form a foamed film. The gap width can be changed with adjusting means so that foamed films of any thickness can be produced. As adjusting means, for example, threaded pins are used according to U.S. Pat. No. 7,296,991B2. The threaded pins are in engagement with a wedge which has one end which presses on the flexible lip. The position of the other end can be changed by means of the threaded pin in such a way that pressure forces of different magnitudes can be transmitted to the flexible lip by means of the wedge. The flexible lip is deformed depending on the magnitude of the compressive force, so that the gap width of the annular gap changes.

In order to adjust the gap width of the annular gap, a plurality of wedges with a corresponding number of threaded pins are arranged on the circumference of the flexible lip.

The flexible lip is pressed segment by segment onto the pressure point by means of the wedges, the position of the flexible lip being adjusted by the rotary movement of the threaded pin.

However, wedges do not automatically slide back into their previous position when the threaded pins are loosened to enlarge the gap width, since the force is introduced almost perpendicular to the opposing surface and the two surfaces are statically arranged with respect to one another. There is therefore a risk that the wedges will not slide back but remain in their position, so that only the threaded pin is unscrewed from the bore in the wedge. Therefore, in practice, when opening the annular gap, a hammer must be used for each threaded pin in order to ensure that the wedges slide back into the intended position. If a steeper angle were chosen, this deficiency could be remedied, but the setting accuracy is reduced. If the gap width must not deviate from the desired gap width by more than 0.1 mm, the required setting accuracy can no longer be guaranteed, so this modification is not suitable for annular nozzles with gap widths within these narrow tolerances. Another disadvantage of this previously known device is its complex production, because standard parts, such as rod material, cannot be used.

The emerging plastic melt also exerts considerable pressure on the flexible lip, which must be absorbed by the threaded pins. It has therefore proven difficult to find a solution that is easily accessible, in which the threaded pins can be adjusted even during operation without using excessive force and the adjustment path is sufficiently small to ensure an exact adjustment.

The object of the invention is to develop a device for adjusting the thickness of a plastic film, by means of which the correct position of the flexible lip can be easily, precisely and reliably adjusted during operation.

### SUMMARY OF THE INVENTION

If the term “for example” is used in the following description, this term relates to exemplary embodiments and/or variants, which is not necessarily to be understood as a more preferred application of the teaching of the invention. The terms “preferably”, “preferred” are to be understood in a similar manner by referring to an example from a set of exemplary embodiments and/or variants, which is not necessarily to be understood as a preferred application of the teaching of the invention. Accordingly, the terms “for example”, “preferably” or “preferred” can relate to a plurality of exemplary embodiments and/or variants.

The following detailed description contains various exemplary embodiments for the annular nozzle according to the invention. The description of a particular annular nozzle is only to be regarded as an example. In the description and claims, the terms “contain”, “comprise”, “have” are interpreted as “including, but not limited to”.

The object of the invention is achieved in that a threaded pin presses on a bolt, which then presses on the flexible lip. A flexible lip is understood to mean a flange-like section of the nozzle body which, when a compressive force is applied, can be rotated about a fulcrum located in the nozzle body, whereby the flexible lip is elastically deformed. An elastic deformation is understood to mean a deformation which disappears again when the compressive force ceases. The deformation of the flexible lip is thus reversible.

An annular nozzle according to the invention contains a nozzle body, the nozzle body comprising at least one annular gap for a discharge of a film. The annular gap is laterally bounded by a stationary wall and a flexible lip. A plurality of threaded pins and a plurality of bolts are arranged in the nozzle body. The threaded pins are rotatably mounted in a first bore in the nozzle body. The bolts are slidably mounted in the nozzle body in a second bore in the nozzle body. Each of the bolts is in contact with the flexible lip and the corresponding threaded pin, so that a compressive force can be transmitted from the threaded pin to the corresponding bolt and via the bolt to the flexible lip. The film can in particular comprise a plastic film. For example, the film can comprise a foamable or foamed plastic film. According to an embodiment, the density of the foamed film can be between 15 and 300 kg/m³.

According to the invention, the gap width of the annular gap is determined by the stationary wall and the flexible lip. The annular gap can be designed as a wedge-shaped gap, that is to say the stationary wall and the flexible lip have an increasing or decreasing distance from one another in the direction of flow of the plastic melt. The opening angle is changed by the compressive force acting on the flexible lip, which is exerted by the bolt on the flexible lip. In particular, a thickness tolerance of less than 0.1 mm can be set with the flexible lip.

Since the bolt and the threaded pin are positively guided in their corresponding bores, one turn of the threaded pin correlates exactly with the displacement of the bolt by a certain length and accordingly with a certain gap width of the annular gap and/or a certain opening angle between the stationary wall and the flexible lip. A rotation is to be understood as a rotary movement about an angle of 360 degrees. The opening angle is forcibly adjusted by turning the threaded pin in the internal thread of the first bore. The further the threaded pin is screwed into the thread, the greater the compressive force acting on the flexible lip. The flexible lip is deflected from its initial position by the pressure force.

When the pressure force is reduced again by loosening the threaded pin, the flexible lip springs back into its original position and pushes the bolt back into its initial position. The counterpressure of the flexible lip automatically moves the bolt back to its initial position, increasing the gap width. Due to the restoring force acting on the bolt from the flexible lip, an exact position of the flexible lip relative to the stationary wall can always be ensured, since the bolt can only move back as far as the position of the threaded pin allows.

The angle between the threaded pin and the bolt can also be used to define the feed path in relation to one revolution of the threaded pin. The threaded pin can in particular have an end region configured as a cone. The steeper the cone angle selected, the more precisely the gap width can be set. The cone angle can in particular be in the range from 10 degrees up to and including 80 degrees. According to an embodiment, the cone angle amounts to 10 degrees up to and including 60 degrees. According to an embodiment, the cone angle amounts to 10 degrees up to and including 40 degrees. In particular, the slope of the cone corresponds to the alignment of the end face of the bolt facing the threaded pin, so that linear contact between the bolt and the threaded pin is possible.

According to an embodiment, the bolt has a first end which contains a first bearing surface. The bolt has a second end which contains a second bearing surface. The first support surface, which can be configured in any way, lies at least partially on the flexible lip. The second bearing surface rests at least partially on the threaded pin along a common line of contact. In particular, the second bearing surface of the bolt rests on the end region of the threaded pin, which is designed as a cone. According to an embodiment, the second bearing surface rests at least partially on a wedge surface of a wedge element.

In particular, the bolt and the threaded pin are arranged at an angle to one another. The angle can lie in a range from 90 degrees up to a maximum of 180 degrees.

According to an embodiment, the number of threaded pins and the associated bolts is at least 10. According to an embodiment, each of the threaded pins is arranged at an angle of a maximum of 30 degrees with respect to the radial direction. According to an embodiment, each of the bolts is arranged perpendicular to the flexible lip with a maximum deviation of 30 degrees from the perpendicular direction with respect to the flexible lip. According to an embodiment, each of the bolts can be displaced by up to 10 mm in the second bore.

According to an embodiment, the second bore contains a stop by means of which the displacement path of the bolt can be limited. In particular, the bolt has a circular cross section. According to an embodiment, the bolt contains a shoulder. According to this embodiment, this shoulder is designed to rest on a stop in the nozzle body.

A method for setting a gap width of an annular gap for the discharge of a plastic melt from an annular nozzle, the annular nozzle comprising a nozzle body which contains the annular gap, the annular gap being laterally bounded by a stationary wall and a flexible lip, wherein a plurality of threaded pins is arranged in the nozzle body a corresponding number of bolts, each of the threaded pins being rotatably mounted in a first bore in the nozzle body, each of the bolts in the nozzle body being slidably mounted in a second bore of the nozzle body, wherein the bolt is in contact with the flexible lip and the corresponding threaded pin, whereby a compressive force is transmitted from the threaded pin to the bolt and via the bolt to the flexible lip when the threaded pin is moved into the first bore of the nozzle body.

In particular, each of the bolts contains a first end which contains a first bearing surface and a second end which contains a second bearing surface, the first bearing surface resting at least partially on the flexible lip and the second bearing surface resting at least partially along a contact line on the threaded pin. The first support surface is in contact with the flexible lip. The second bearing surface is in contact with the corresponding threaded pin, so that when the threaded pin is rotated, the bolt is displaced in the second bore. The first bore is intended to receive the threaded pin and contains a thread so that the threaded pin can be moved into the first bore by a rotary movement or can be moved out of the second bore by a rotary movement in the opposite direction.

An advantage of the device according to the invention and of the associated method is that it enables a precise adjustment of the gap width of the annular gap.

An annular nozzle according to one of the preceding embodiments can be used in particular for the production of foamed plastic films.

### BRIEF DESCRIPTION OF THE DRAWINGS

The system according to the invention is illustrated below with the aid of a few embodiments. It is shown in

FIG. 1 a section through the upper half of an inventive annular nozzle according to a first embodiment,

FIG. 2 a view of an annular nozzle according to the first embodiment,

FIG. 3 a section through the upper half of an inventive annular nozzle according to a second embodiment,

FIG. 4 a partial section through an inventive annular nozzle according to a third embodiment,

FIG. 5 a partial section through an annular nozzle according to a fourth embodiment, and

FIG. 6 a view of the annular nozzle according to the third or fourth embodiment.

### DETAILED DESCRIPTION

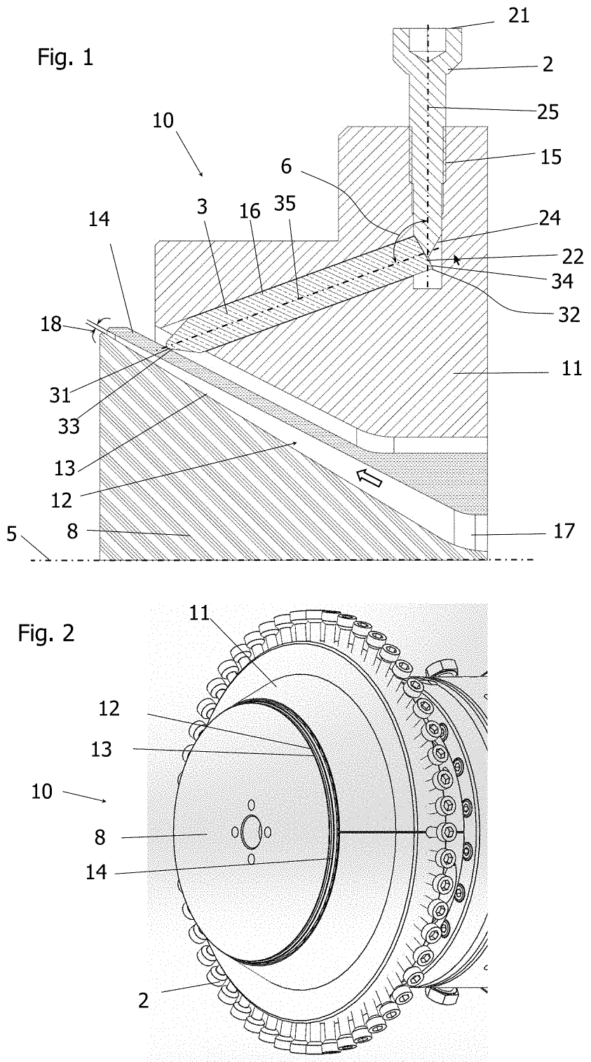

FIG. 1 shows a section through the upper half of an annular nozzle 10 according to a first embodiment of the invention. The annular nozzle 10 contains a nozzle body 11. The nozzle body 11 comprises at least one annular gap 12 for the discharge of a film, the annular gap 12 being laterally delimited by a stationary wall 13 and a flexible lip 14. A plurality of threaded pins 2 and a corresponding number of bolts 3 are arranged in the nozzle body 11, each of the threaded pins 2 being rotatably mounted in a first bore 15 in the nozzle body 11. In the present illustration, only a single threaded pin 2 is shown; the threaded pins 2 located behind are omitted in this illustration for the sake of simplicity.

Each of the bolts 3 is slidably mounted in the nozzle body 11 in a second bore 16 of the nozzle body 11. The bolt 3 is in contact with the flexible lip 14 and the corresponding threaded pin 2. A compressive force can be transmitted from the threaded pin 2 to the bolt 3 and via the bolt 3 to the flexible lip 14. The threaded pin 2 presses on the bolt 3 and the bolt 3 presses on the flexible lip 14 in order to change its position relative to the stationary wall 13. Therefore, the bolt 3 rests on the flexible lip 14, but the bolt 3 is not connected to the flexible lip 14, that is, there is no material connection between the bolt 3 and the flexible lip 14. The bolt 3 and the threaded pin 2 also lie against one another. The bolt 3 is also not connected to the threaded pin 2, that is, there is no material connection between the bolt 3 and the threaded pin 2.

According to the present embodiment, the bolt 3 has a first end 31 containing a first bearing surface 33 and a second end 32 containing a second bearing surface 34. The first bearing surface 33 rests at least partially on the flexible lip 14 and the second bearing surface 34 rests at least partially on the threaded pin 2 along a common line of contact.

In particular, the bolt 3 and the threaded pin 2 are arranged at an obtuse angle 6 to one another. The bolt 3 and the threaded pin 2 are configured in particular as rotationally symmetrical components. The bolt 3 is provided with a bolt center axis 35 if it is designed as a rotationally symmetrical component. The threaded pin 2 has a threaded pin center axis 25 if it is configured as a rotationally symmetrical component. According to this embodiment, the bolt center axis 35 and the threaded pin center axis 25 span a common plane which, in FIG. 1, corresponds to the sectional plane for the illustrated threaded pin 2 and the corresponding bolt 3. The obtuse angle 6 can lie in the range from 100 degrees up to and including a maximum of 180 degrees. The angle 6 between the threaded pin 2 and the bolt 3 can also be used to define the feed path as desired. The obtuse angle 6 is spanned between the bolt center axis 35 and the threaded pin center axis 25.

The threaded pin comprises a first end 21 and an opposite second end 22. The first end 21 is configured to perform a rotary movement around the threaded pin center axis 25 acting as the axis of rotation using a tool, in the present example an Allen key. The first bore 15 has an internal thread which engages with an external thread located on the circumference of the threaded pin 2.

The threaded pin 2 can in particular be disposed with a second support surface 24 configured as a cone in the region of the second end 22. The steeper the cone angle 26 of the cone is selected, the more precisely the gap width of the annular gap 12 can be adjusted. The cone angle 26 can in particular lie in the range from 10 degrees up to and including 80 degrees, preferably the cone angle lies in the range from 10 up to and including 60 degrees, particularly preferably the cone angle lies in the range from 10 up to and including 40 degrees. In particular, the slope of the cone corresponds to the alignment of the second bearing surface 34 of the bolt 3, so that a linear contact can be obtained between the second bearing surface 34 of the bolt 3 and the second support surface 24 of the threaded pin 2.

FIG. 1 also shows a channel 17 which serves to convey a fluid medium, for example a plastic melt for the production of a plastic film, in particular a foamed plastic film. A fluid medium is understood to mean any flowable medium, for example a liquid medium or a multiphase medium, for example an emulsion, a slurry, a solution. A multiphase medium can comprise any combination consisting of at least a liquid, a gas or a solid.

The channel 17 runs through the nozzle body 11 and opens into the annular gap 12. As in the previous exemplary embodiment, the annular gap 12 is delimited by a stationary wall 13 and a flexible lip 14.

The annular gap 12 is delimited by the stationary wall 13 and the side wall of the flexible lip 14 on the gap side. The gap width of the annular gap 12 is thus determined by the stationary wall 13 and the side wall of the flexible lip 14 on the gap side. The annular gap 12 can be configured as a wedge-shaped gap, that is, the stationary wall 13 and the side wall on the gap side of the flexible lip 14 have a decreasing distance from one another in the direction of flow of the fluid medium. The opening angle 18 is changed by the compressive force acting on the flexible lip 14, which is exerted by the bolt 2 on the flexible lip 14. The direction of flow of the fluid medium is marked with an arrow positioned in the channel 17.

According to the embodiment shown in FIG. 1, the flexible lip 14 is configured as an annular element. According to a variant not shown, the annular element can be fastened to the nozzle body 11 or to a central body 8 supporting the stationary wall 13 by means of a fastening element.

Since the bolt 3 and the threaded pin 2 are positively guided in their corresponding bores 15, 16, a rotation of the threaded pin 2 correlates exactly with the displacement of the bolt 3 by a certain length and accordingly with a certain gap width of the annular gap 12 and/or a certain opening angle 18 between the stationary wall 13 and the flexible lip 14. If the annular gap 3 is configured as a wedge-shaped gap, the opening angle 18 is forcibly adjusted by each rotation of the threaded pin in the internal thread of the first bore 15. The further the threaded pin 2 is screwed into the internal thread of the bore 15, the greater the compressive force becomes which acts on the flexible lip 14. The flexible lip 14 is deflected from its initial position by the compressive force. FIG. 1 shows an intermediate position according to which part of the second bearing surface 34 rests partially on the second support surface 24 which adjoins the second end 22. The intermediate position lies between the initial position, according to which the annular gap has a maximum gap width, and a final position, according to which the annular gap has a minimum gap width.

When the compressive force is reduced again by loosening the threaded pin 2, the flexible lip 14 springs back into its original position and pushes the bolt 3 back into the initial position. As a result of the counter-pressure of the flexible lip, the bolt 3 automatically moves back into the initial position, increasing the gap width. Due to the restoring force acting on the bolt 3 from the flexible lip 14, an exact position of the flexible lip 14 relative to the stationary wall 13 can always be ensured, since the bolt 3 can only move back as far as the selected position of the threaded pin 2 allows.

The threaded pin 2 can be arranged at an angle of a maximum of 30 degrees with respect to the radial direction. According to FIG. 1 or FIG. 2, the threaded pin is arranged in the radial direction. This means that the threaded pin center axis 15 lies in a plane which is arranged perpendicular to the longitudinal axis 5 of the annular nozzle 10. Of course, the angle between the threaded pin center axis 15 and the longitudinal axis 5 in the present sectional plane can deviate from 90 degrees; in particular, it can deviate by up to 30 degrees from the vertical position, which, depending on the design of the annular nozzle 10, can facilitate access to the threaded pins 2.

According to this embodiment, the bolt 3 is arranged at an angle to the flexible lip, wherein the bolt center axis 35 encloses an angle of a maximum of 45 degrees with the upper cut edge of the flexible lip 14 according to the illustration. The bolt 3 has a first end 31 and a second end 32, the first end 31 being in contact with the flexible lip 14 by means of a first bearing surface 33. According to this embodiment, the bearing surface 33 is smaller than in the following embodiments, since the bolt 3 is provided with a conical section at its first end.

It is of course also possible that the conical section tapers to a point, but the surface pressure on the flexible lip 14 at the point of contact becomes very high, so that a surface treatment of the flexible lip may have to be carried out in the contact region.

The threaded pin 2 can be arranged at an angle of a maximum of 30 degrees with respect to the radial direction. According to FIG. 1, the threaded pin is arranged in the radial direction. This means that the threaded pin center axis 15 lies in a plane which is arranged perpendicular to the longitudinal axis 5 of the annular nozzle 10. Of course, the angle between the threaded pin center axis 15 and the longitudinal axis 5 in the present sectional plane can deviate from 90 degrees; in particular, it can deviate by up to 30 degrees from the vertical position, which, depending on the design of the annular nozzle 10, can facilitate access to the threaded pins 2. According to an embodiment, the bolt 3 can be displaced by up to and including 10 mm in the second bore 16. According to an embodiment, the bolt can be displaced 3 mm up to and including 10 mm in the second bore 16.

FIG. 2 shows a view of an annular nozzle 10 which comprises a nozzle body 11 which contains an annular gap 12 through which a fluid medium, for example a plastic melt, is discharged in the operating state. The annular gap 12 is arranged between a stationary wall 13 of a central body 8 and a flexible lip 14. A plurality of threaded pins 2 are arranged on the circumference of the nozzle body 11. The number of threaded pins 2 and the associated bolts, which are not visible in this illustration, is at least 10. According to the embodiment shown in FIG. 2, the flexible lip 14 is configured as an annular element. A channel 17 for a fluid medium extends between the stationary wall 13 of the central body 8 and the annular element.

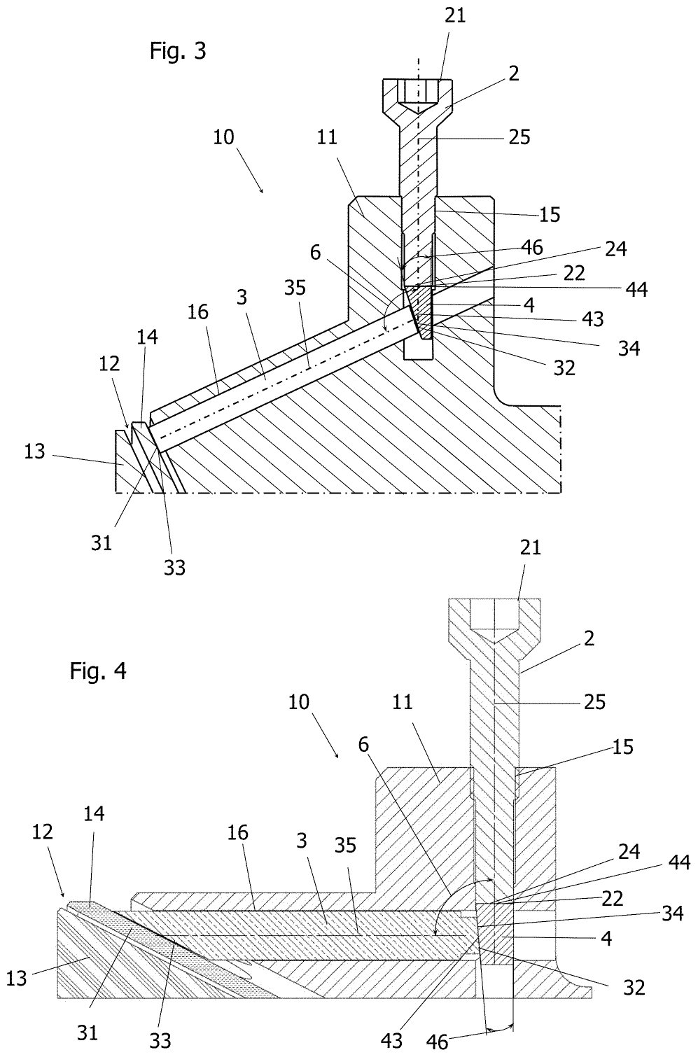

FIG. 3 shows a partial section through an inventive annular nozzle 10 according to a second exemplary embodiment. Components that are the same or have the same effect are provided with the same reference symbols as in the embodiment described above. The annular nozzle 10 contains a nozzle body 11, a section of which is shown. The nozzle body 11 comprises at least one annular gap 12 for the discharge of a film, the annular gap 12 being laterally delimited by a stationary wall 13 and a flexible lip 14. A plurality of threaded pins 2 and a corresponding number of bolts 3 are arranged in the nozzle body 11, each of the threaded pins 2 being rotatably mounted in a first bore 15 in the nozzle body 11. In the present illustration, only a single threaded pin 2 is shown; the threaded pins 2 located behind are omitted in this illustration for the sake of simplicity.

Each of the bolts 3 is slidably mounted in the nozzle body 11 in a second bore 16 of the nozzle body 11. The bolt 3 is in contact with the flexible lip 14 and the corresponding threaded pin 2 via a wedge element 4. A compressive force can be transmitted from the threaded pin 2 to the wedge element 4, from the wedge element 4 to the bolt 3 and via the bolt 3 to the flexible lip 14. The threaded pin 2 presses on the wedge element 4 and the bolt 3 presses on the flexible lip 14 in order to change its position relative to the stationary wall 13. Therefore, the bolt 3 rests on the flexible lip 14, but the bolt 3 is not connected to the flexible lip 14, that is, there is no material connection between the bolt 3 and the flexible lip 14. The bolt 3 and the wedge element 4 also lie against one another. The bolt 3 is also not connected to the wedge element 4, that is, there is no material connection between the bolt 3 and the wedge element 4. The wedge element 4 and the threaded pin 2 also rest against one another. The threaded pin 2 is also not connected to the wedge element 4, that is, there is no material connection between the threaded pin 2 and the wedge element 4.

According to the present embodiment, the bolt 3 has a first end 31 containing a first bearing surface 33 and a second end 32 containing a second bearing surface 34. The first bearing surface 33 rests on the flexible lip 14 and the second bearing surface 34 rests at least partially on the wedge element 4 along a common line of contact.

In particular, the bolt 3 and the wedge element 4 are arranged at an obtuse angle 6 with respect to one another. The bolt 3 and the threaded pin 2 are configured in particular as rotationally symmetrical components. The bolt 3 has a bolt center axis 35 if it is designed as a rotationally symmetrical component. The threaded pin 2 has a threaded pin center axis 25 if it is configured as a rotationally symmetrical component. According to this embodiment, the bolt center axis 35 and the threaded pin center axis 25 span a common plane which, in FIG. 4, corresponds to the sectional plane for the illustrated threaded pin 2 and the corresponding bolt 3. The angle 6 can lie in the range from 90 degrees up to and including a maximum of 180 degrees. The angle 6 between the threaded pin 2 and the bolt 3 can also be used to define the feed path as desired.

The threaded pin comprises a first end 21 and an opposite second end 22. The first end 21 is configured to perform a rotary movement around the threaded pin center axis 25 acting as the axis of rotation using a tool, in the present example an Allen key. The first bore 15 has an internal thread which engages with an external thread located on the circumference of the threaded pin 2.

In the region of the second end 22, the threaded pin 2 can in particular be disposed with a second support surface 24, which is configured as a flat surface and which is configured to support a second support surface 44 of the wedge element 4. According to an embodiment not shown, engagement elements can be provided on the wedge element 4 and on the second end 22 of the threaded pin in order to ensure the correct alignment of the wedge element 4 in the first bore 15.

The steeper the wedge angle 46 of the wedge element 4 is selected, the more precisely the gap width of the annular gap 12 can be adjusted. The wedge angle 46 can in particular lie in the range from 10 degrees up to and including 75 degrees. According to an embodiment, the wedge angle lies in the range from 10 up to and including 50 degrees. According to an embodiment, the wedge angle lies in the range from 10 up to and including 40 degrees. In particular, the alignment of the wedge surface 43 corresponds to the alignment of the second bearing surface 34 of the bolt 3, so that a planar contact can be obtained between the second bearing surface 34 of the bolt 3 and the wedge surface 43. The wedge element 4 can also prevent the bolt 3 from being pushed out of the second bore 16 if the bore 16 is configured as a through bore. In particular, the bolt 3 has a circular cross section.

FIG. 4 shows a partial section through an inventive annular nozzle 10 according to a third embodiment. Components that are the same or have the same effect are provided with the same reference symbols as in the embodiments described above. The annular nozzle 10 contains a nozzle body 11, a section of which is shown. The nozzle body 11 comprises at least one annular gap 12 for the discharge of a film, the annular gap 12 being laterally delimited by a stationary wall 13 and a flexible lip 14. A plurality of threaded pins 2 and a corresponding number of bolts 3 are arranged in the nozzle body 11, each of the threaded pins 2 being rotatably mounted in a first bore 15 in the nozzle body 11. In the present illustration, only a single threaded pin 2 is shown; the threaded pins 2 located behind are omitted in this illustration for the sake of simplicity.

Each of the bolts 3 is slidably mounted in the nozzle body 11 in a second bore 16 of the nozzle body 11. The bolt 3 is in contact with the flexible lip 14 and the corresponding threaded pin 2 via a wedge element 4. A compressive force can be transmitted from the threaded pin 2 to the wedge element 4, from the wedge element 4 to the bolt 3 and via the bolt 3 to the flexible lip 14. The threaded pin 2 presses on the wedge element 4 and the bolt 3 presses on the flexible lip 14 in order to change its position relative to the stationary wall 13.

Therefore, the bolt 3 rests on the flexible lip 14, but the bolt 3 is not connected to the flexible lip 14, that is, there is no material connection between the bolt 3 and the flexible lip 14. The bolt 3 and the wedge element 4 also lie against one another. The bolt 3 is also not connected to the wedge element 4, that is, there is no material connection between the bolt 3 and the wedge element 4. The wedge element 4 and the threaded pin 2 also rest against one another. The threaded pin 2 is also not connected to the wedge element 4, that is, there is no material connection between the threaded pin 2 and the wedge element 4.

According to the present embodiment, the bolt 3 has a first end 31 containing a first bearing surface 33 and a second end 32 containing a second bearing surface 34. The first bearing surface 33 rests on the flexible lip 14 and the second bearing surface 34 rests at least partially on the wedge element 4 along a common line of contact.

According to the present embodiment, the bolt 3 and the wedge element 4 are arranged at a right angle 6 to one another. The threaded pin 2 is configured as a rotationally symmetrical component. The bolt 3 has a bolt center axis 35. The threaded pin 2 has a threaded pin center axis 25. According to this embodiment, the bolt center axis 35 and the threaded pin center axis 25 span a common plane which, in FIG. 4, corresponds to the sectional plane for the illustrated threaded pin 2 and the corresponding bolt 3. The angle 6 can be 90 degrees or more. The angle 6 between the threaded pin 2 and the bolt 3 can also be used to define the feed path as desired.

The threaded pin comprises a first end 21 and an opposite second end 22. The first end 21 is configured to perform a rotary movement around the threaded pin center axis 25 acting as the axis of rotation using a tool, in the present example an Allen key. The first bore 15 has an internal thread which engages with an external thread located on the circumference of the threaded pin 2.

In the region of the second end 22, the threaded pin 2 can in particular be disposed with a second support surface 24, which is configured as a flat surface and which is configured to support a second support surface 44 of the wedge element 4. According to an embodiment not shown, engagement elements can be provided on the wedge element 4 and on the second end 22 of the threaded pin in order to ensure the correct alignment of the wedge element 4 in the first bore 15.

The steeper the wedge angle 46 of the wedge element 4 is selected, the more precisely the gap width of the annular gap 12 can be adjusted. The wedge angle 46 can in particular lie in the range from 10 degrees up to and including 75 degrees. According to an embodiment, the wedge angle lies in the range from 10 up to and including 50 degrees. According to an embodiment, the wedge angle lies in the range from 10 up to and including 40 degrees. In particular, the alignment of the wedge surface 43 corresponds to the alignment of the second bearing surface 34 of the bolt 3, so that a planar contact can be obtained between the second bearing surface 34 of the bolt 3 and the wedge surface 43. The wedge element 4 can also prevent the bolt 3 from being pushed out of the second bore 16 if the bore 16 is designed as a through bore. In particular, the bolt 3 has a circular cross section.

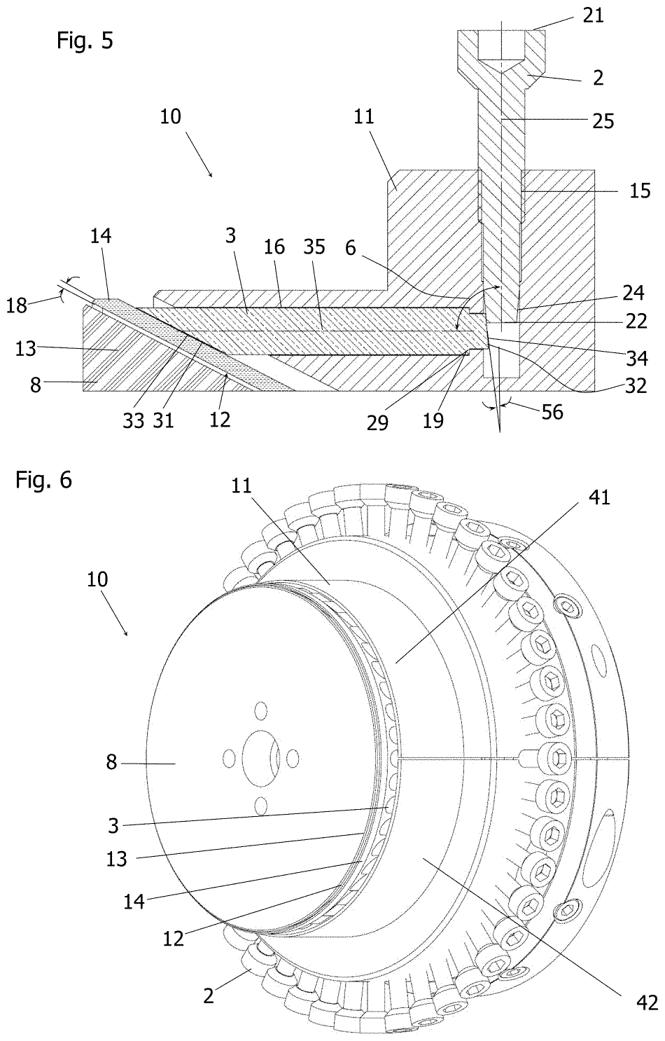

FIG. 5 shows a partial section through an inventive annular nozzle 10 according to a fourth embodiment. Components that are the same or have the same effect are provided with the same reference symbols as in the embodiments described above. The annular nozzle 10 contains a nozzle body 11, a section of which is shown. The nozzle body 11 comprises at least one annular gap 12 for the discharge of a film, the annular gap 12 being laterally delimited by a stationary wall 13 of a central body 8 and a flexible lip 14. A plurality of threaded pins 2 and a corresponding number of bolts 3 are arranged in the nozzle body 11, each of the threaded pins 2 being rotatably mounted in a first bore 15 in the nozzle body 11. In the present illustration, only a single threaded pin 2 is shown; the threaded pins 2 located behind are omitted in this illustration for the sake of simplicity.

Each of the bolts 3 is slidably mounted in the nozzle body 11 in a second bore 16 of the nozzle body 11. The bolt 3 is in contact with the flexible lip 14 and the corresponding threaded pin 2. A compressive force can be transmitted from the threaded pin 2 to the bolt 3 and via the bolt 3 to the flexible lip 14. The threaded pin 2 presses on the bolt 3 and the bolt 3 presses on the flexible lip 14 in order to change its position relative to the stationary wall 13. Therefore, the bolt 3 rests on the flexible lip 14, but the bolt 3 is not connected to the flexible lip 14, that is, there is no material connection between the bolt 3 and the flexible lip 14. The bolt 3 and the threaded pin 2 also lie against one another. The threaded pin 2 is also not connected to the bolt 3, that is, there is no material connection between the threaded pin 2 and the bolt 3.

According to the present embodiment, the bolt 3 has a first end 31 containing a first bearing surface 33 and a second end 32 containing a second bearing surface 34. The first bearing surface 33 rests on the flexible lip 14 and the second bearing surface 34 rests at least partially on the threaded pin 2 along a common line of contact.

According to the present embodiment, the bolt 3 and the threaded pin are arranged at a right angle 6 to one another. The threaded pin 2 is designed as a rotationally symmetrical component. The bolt 3 has a bolt center axis 35. The threaded pin 2 has a threaded pin center axis 25. According to this embodiment, the bolt center axis 35 and the threaded pin center axis 25 span a common plane which, in FIG. 5, corresponds to the sectional plane for the illustrated threaded pin 2 and the corresponding bolt 3. The angle 6 can be 90 degrees or, as shown in the first and second exemplary embodiments, be designed as an obtuse angle, i.e., in the range from 100 degrees up to and including 180 degrees. The angle 6 between the threaded pin 2 and the bolt 3 can also be used to define the feed path as desired.

The threaded pin comprises a first end 21 and an opposite second end 22. The first end 21 is designed to perform a rotary movement around the threaded pin center axis 25 acting as the axis of rotation using a tool, in the present example an Allen key. The first bore 15 has an internal thread which engages with an external thread located on the circumference of the threaded pin 2.

In the region of the second end 22, the threaded pin 2 can in particular be disposed with a second support surface 24, which is configured as a conical section and which is configured to bear a second bearing surface 34 of the bolt 3. According to the illustrated embodiment, the inclination of the conical section of the second end 22 corresponds to the inclination of the second bearing surface 34 of the bolt 3.

The steeper the angle of the conical section is selected, the more precisely the gap width of the annular gap 12 can be adjusted. The angle 56 which the conical section includes with the threaded pin center axis 15 can in particular be in the range up to and including 40 degrees. According to an embodiment, the angle is up to and including 30 degrees. According to an embodiment, the angle is up to and including 20 degrees. The angle 56 corresponds to half the cone angle 26 according to FIG. 1. In particular, the alignment of the support surface corresponds to the alignment of the second bearing surface 34 of the bolt 3, so that linear contact can be obtained between the second bearing surface 34 of the bolt 3 and the support surface 24. In particular, the bolt 3 has a circular cross section.

The bolt 3 can be provided with a shoulder 29 which can be received in a stop 19 of the nozzle body 11. This shoulder 29 prevents the second end 32 of the bolt from protruding too far into the bore 15 for the threaded pin 2, so that the bolt cannot hinder or prevent the movement of the threaded pin 2 in the direction of the bottom of the bore.

FIG. 6 shows a view of the annular nozzle 10 according to the third or fourth embodiment, which comprises a nozzle body 11 which comprises an annular gap 12 through which a fluid medium, for example a plastic melt, is discharged in the operating state. The annular gap 12 is arranged between a stationary wall 13 of a central body 8 and a flexible lip 14. A plurality of threaded pins 2 are arranged on the circumference of the nozzle body 11. The number of each of the threaded pins 2 and the associated bolts, which are not visible in this illustration, is at least 10. The nozzle body 11 is composed of two parts according to this embodiment, so that the bores 16 for the bolts 3 can be produced and the bolts can be inserted into the corresponding bores 16 before the corresponding nozzle body section 41, 42 of the nozzle body 11 can be positioned on the flexible lip 13. According to an embodiment not shown, the nozzle body 11 could also be formed in several parts, that is to say, it can consist of more than two partial bodies.

It is obvious to a person skilled in the art that many further variants are possible in addition to the embodiments described without deviating from the inventive concept. The subject matter of the invention is therefore not restricted by the preceding description and is determined by the scope of protection which is defined by the claims. The broadest possible reading of the claims is authoritative for the interpretation of the claims or the description. In particular, the terms “contain” or “include” are to be interpreted in such a way that they refer to elements, components or steps in a non-exclusive meaning, which is intended to indicate that the elements, components or steps can be present or are used that they can be combined with other elements, components or steps that are not explicitly mentioned. When the claims relate to an element or component from a group which may consist of A, B, C to N elements or components, this formulation should be interpreted in such a way that only a single element of that group is required, and not combination of A and N, B and N, or any other combination of two or more elements or components of this group.

What is claimed is:

1. An annular nozzle containing a nozzle body, the nozzle body comprising at least one annular gap for the discharge of a film, the annular gap being laterally bounded by a stationary wall and a flexible lip, a plurality of threaded pins and a plurality of bolts being arranged in the nozzle body, wherein the threaded pins are rotatably mounted in a first bore in the nozzle body, wherein the bolts in the nozzle body are slidably mounted in a second bore in the nozzle body, wherein each of the bolts is in contact with the flexible lip and the corresponding threaded pin, so that a compressive force can be transmitted from the threaded pin to the corresponding bolt and via the bolt to the flexible lip.

2. The annular nozzle of claim 1, wherein the bolt has a first end containing a first bearing surface and a second end containing a second bearing surface, wherein the first bearing surface rests at least partially on the flexible lip and the second bearing surface rests at least partially along a common line of contact on the threaded pin or rests on a wedge surface of a wedge element.

3. The annular nozzle of claim 1, wherein the bolt and the threaded pin are arranged at an angle with respect to each other.

4. The annular nozzle of claim 3, wherein the angle is 90 degrees up to and including a maximum of 180 degrees.

5. The annular nozzle of claim 1, wherein the threaded pins are arranged at equidistant intervals from one another on the circumference of the nozzle body.

6. The annular nozzle of claim 1, wherein the number of each of the threaded pins and the associated bolts is at least 10.

7. The annular nozzle of claim 1, wherein each of the threaded pins is arranged at an angle of at most 30 degrees with respect to the radial direction.

8. The annular nozzle of claim 1, wherein each of the bolts is arranged perpendicular to the flexible lip with a maximum deviation of 30 degrees from the perpendicular direction with respect to the flexible lip.

9. The annular nozzle of claim 1, wherein each of the bolts can be displaced in the bore by up to 10 mm.

10. The annular nozzle of claim 1, wherein each of the threaded pins is provided with an end which contains a conical section.

11. The annular nozzle of claim 10, wherein the cone has a cone angle which is in the range of 10 degrees up to and including 80 degrees.

12. The annular nozzle of claim 1, wherein the second bore contains a stop by means of which the displacement path of the bolt can be limited.

13. The annular nozzle of claim 1, wherein the bolt contains a shoulder.

14. The annular nozzle of claim 1, wherein the bolt has a circular cross section.

15. The annular nozzle of claim 1, wherein the film comprises a foamed plastic film.
